(19) United States
(12) Patent Application Publication
(10) Pub. No.: US 2003/0046247 A1
(43) Pub. Date: Mar. 6, 2003

(54) Cardholder transaction control methods, apparatus, signals and media

(76) Inventor: Janos G. Stiasny, Port Moody (CA)

Correspondence Address: DOWELL & DOWELL PC, SUITE 309, 1215 JEFFERSON DAVIS HIGHWAY, ARLINGTON, VA, 22202

(21) Appl. No.: 09/943,003

(22) Filed: Aug. 31, 2001

(51) Int. Cl. G06F 17/60

(52) U.S. Cl. 705/65

(57) ABSTRACT

Methods, apparatus, signals and media for conducting a cardholder transaction are disclosed. One such method involves authorizing a transaction to proceed in response to receiving an identification of an adjudicator confirming that computer readable information retrieved from a card matches a feature of a bearer of the card while the information is being presented to the adjudicator.

### BACKGROUND OF THE INVENTION

1. Field of Invention

This invention relates to electronic transactions, and more particularly, to methods, apparatus, signals and media for conducting and/or controlling a cardholder transaction.

2. Description of Related Art

The financial services industry facilitates online and offline financial transactions between customers and commercial enterprises currently involving about $1.8 trillion a year globally. The bulk of these transactions involve the use of revolving/installment credit, debit or other cards for financial transactions such as Visa®, Mastercard®, American Express®, Diners Club®, Novus®, or Europay® cards, for example. While most financial transactions are legitimate, some are fraudulent. It is estimated that up to 2.6% of every dollar transacted is lost to fraud. When a fraudulent transaction occurs, the merchant involved in the transaction is responsible to pay a fee to the issuer of the card for inadvertently allowing the fraudulent transaction to occur and suffers a loss for failure to recover charges for goods or services rendered by the merchant. This puts a strong onus of responsibility on the merchant to follow industry standard policies to timely and correctly authenticate the bearer of the card.

Existing offline transaction mechanisms at a point of sale (POS) or point of interaction (POI) at a commercial enterprise involve the use of cards which have identifying indicia on the front of the card, such as embossed letters identifying the account number, card expiry date, and the name of the person or entity that is authorized to use the card to make charges or debits to the account identified by the account number. In addition, cards typically have verification indices laser printed on a signature strip on the rear side of the card, and have a magnetic strip on which information about the cardholder is stored. Some cards may also or alternatively carry a photograph of the authorized user of the card. The authorized card user is requested to sign the card on the signature strip.

Under an agreement between commercial enterprises, banking institutions, lending institutions and private label card operators, such as Esso® and Shell®, for example, the commercial enterprise is responsible for positive cardholder identification. To positively identify a cardholder, the commercial enterprise is required to verify that the laser indicia on the back of the card matches the embossed indicia on the front of the card, verify that the card has not expired, by examining the expiry date on the card, and verify that a signature on a draft certificate signed by the bearer of the card or a digitized signature entered on a digitizing pad by the bearer matches the signature on the back of the card; and where appropriate verify that a photograph of the authorized user of the card depicts the bearer of the card.

Unfortunately, some of these steps may be omitted and/or performed in error due to clerk and/or user ignorance of applicable policies, time considerations, or other conditions intrinsic to the environment in which the financial transaction takes place. For example, at restaurants a cardholder usually signs a presented draft certificate and leaves the restaurant before the waiter or waitress retrieves the signed draft certificate, and thus the signature cannot be compared directly to the signature on the card used.

A problem with existing offline transaction mechanisms, such as magnetic stripe readers for reading the magnetic stripe embedded onto or in the card, is that the only identification that links the user of the card to the person authorized to use the card is a signature and/or a photo on the card.

However, unscrupulous persons may easily tamper with the photo, signature, and/or the embossed card indices. Some cards have holograms which are destroyed if the card is tampered with, however, the laminate covering the card may still be removed and the hologram and/or the photo may be removed and substituted with a fraudulent hologram or photo. In addition, the embossed indices may be tampered with, changed or otherwise altered. When presented with a carefully altered card, the merchant may have no way of proving that the bearer of the card is authentic.

An attempt to reduce fraudulent online transactions has involved the use of a personal identification number (PIN) that the bearer of the card enters into a terminal at the time of the transaction. The PIN and information stored on the magnetic strip is sent via telephone or data communications network to a remote computer server at a host institution for verification against a reference PIN and information previously provided by the authorized user and stored on the server. If the entered PIN and magnetic stripe information matches the stored information an authorization message is sent back to the POS/POI terminal to allow the transaction to proceed. This may reduce the occurrence of fraud at the POS/POI terminal but it involves the transmission of personal information over a telephone line. The information is susceptible to eavesdropping and tapping, whereby an unscrupulous person could obtain access to the account number, associated PIN, or any other user identification information. Encryption may be used to provide some security, however even encrypted data can be intercepted and decoded.

Moreover, unscrupulous merchants or unscrupulous employees of merchants may utilize fake and/or redundant magnetic strip readers to capture cardholder information and PINs for fraudulent use.

Other attempts to reduce fraud have involved the use of embedded smart chips on the card replacing the magnetic strip, which provides greater storage capability enabling storage of a larger amount of encrypted information and allowing read/write capability. This facilitates confirmation of PINs and other data without external communication, by avoiding the use of external telephone lines to verify the PIN entered at the POS/POI terminal.

However, it has been found that some unscrupulous persons have installed cameras to watch the bearer of the card enter his or her associated PIN number and have used duplicate card readers to extract information from the card.

The security of existing financial transaction systems is therefore suspect, in both offline and online transactions. What is desirable therefore are methods and apparatus for reducing the incidence of fraudulent transactions at POS/POIs.

### SUMMARY OF THE INVENTION

In accordance with one aspect of the invention there is provided a method of conducting a cardholder transaction. The method involves presenting information stored on a card in electronic form, for review by an adjudicator. The method further involves sensing identification of the adjudicator reviewing the information at the time the information is presented, and authorizing the completion of a transaction in response to receipt of the identification of the adjudicator.

In accordance with another aspect of the invention there is provided a method of conducting a cardholder transaction. The method involves authorizing a transaction to proceed in response to receiving an identification of an adjudicator confirming that computer readable information retrieved from a card matches a feature of a bearer of the card while the information is being presented to the adjudicator.

The method may further involve receiving data stored on the card to enable a representation of the data to be presented to the adjudicator to permit the adjudicator to compare the representation with the feature of the bearer of the card. The method may also further involve receiving the identification of the adjudicator, and receiving the identification while the information is being presented to the adjudicator. Receiving the confirmation may involve sensing an identity of the adjudicator.

The method may further involve causing the information to be presented to the adjudicator by producing a signal for use by an annunciation device to cause the annunciation device to present the information to the adjudicator, in response to information received from the card.

The method may also involve reading data stored on the card to enable a representation of the data to be presented to the adjudicator to permit the adjudicator to compare the representation with the feature of the bearer of the card. This may involve retrieving an image file representing an image from the card, and causing the image to be presented to the adjudicator by producing a representation of the image for viewing by the adjudicator.

The method may also involve sensing an identity of the adjudicator while the image is being presented to produce the identification of the adjudicator. This may involve retrieving an audio file and/or a fingerprint file from a card carried by the adjudicator, and/or receiving an identification code associated with the adjudicator.

The method may further involve reading, from a computer readable medium, an identification code identifying the adjudicator, and/or producing a representation of a fingerprint, a signature, an audio or an iris signature of the adjudicator and comparing the representation to a reference fingerprint, signature, audio, and/or iris signature to determine the identity of the adjudicator. This may alternatively or in addition involve receiving a key code from a key sensor operable to sense a key associated with the adjudicator.

Authorizing may involve enabling a message relating to the transaction to be transmitted to an account service, and/or associating the transaction with the adjudicator by associating the identification of the adjudicator with the transaction.

The method may also involve preventing the transaction from proceeding unless an identity of the adjudicator is received. The method may also involve preventing transaction data from being transmitted to a transaction processor unless an adjudicator is identified while the information is being presented.

The method may also involve receiving a personal identification number from the bearer of the card and preventing the personal identification number from being passed to a point of transaction terminal unless the identification of the adjudicator is received.

The method may further involve acquiring transaction data representing the transaction and associating the identification of the adjudicator with the transaction data, and may involve producing a transaction record associating the identification of the adjudicator with the transaction data, and causing the transaction record to be stored.

In accordance with another aspect of the invention there is provided an apparatus for controlling a cardholder transaction. The apparatus includes a card interface, an identification interface, and a transaction controller. The card interface is operable to receive an indication that information stored on a card is being presented to an adjudicator. The identification interface is operable to receive an identification of the adjudicator confirming that the information stored on the card matches a feature of a bearer of the card. The transaction controller is operable to produce a signal indicative of whether or not a transaction should proceed, in response to whether or not the identification of the adjudicator is received while the information is being presented to the adjudicator.

The apparatus may also include an annunciator interface for receiving information stored on the card and for producing an annunciation signal in response to the information stored on the card. The annunciation signal may be operable to control an annunciator to annunciate the information and to cause an image derived from the information to be produced on a display.

The apparatus may also include a card reader in communication with the card interface, for reading data stored on the card to enable a representation of the data to be presented to the adjudicator to permit the adjudicator to compare the representation with the feature of the bearer of the card. A card reader driver may also be included which may be operable to control the card reader to retrieve an image file, an audio file, or a fingerprint file from the card.

The apparatus may further include an annunciator interface operable to receive the image file from the card reader interface and to provide the image file to an annunciation device to cause the image to be presented to the adjudicator. An annunciation device may be in communication with the annunciator interface for producing a representation of the image file for viewing by the adjudicator. The transaction controller may be operable to receive the identification of the adjudicator while the image is being presented.

The apparatus may further include an annunciation controller for controlling annunciation of information retrieved from the card.

The apparatus may further include an identification code interface operable to receive a code from the bearer of the card and the transaction controller may be operable to prevent the code from being passed to a point of transaction terminal unless the identification of the adjudicator is received.

The apparatus may also include a sensor in communication with the identification interface for sensing an identity of the adjudicator. The sensor may be operable to receive an identification code associated with the adjudicator, to read the identification code from a computer readable medium, and/or to produce a representation of a fingerprint, a signature, an audio or iris signature of the adjudicator. The identification interface may be operable to compare the fingerprint, signature, audio or iris signature representation with a reference fingerprint, signature, audio or iris signature representation to determine the identity of the adjudicator. The sensor may be operable to produce a key code in response to sensing a key associated with the adjudicator.

The transaction controller may be operable to prevent the transaction from proceeding unless the identification is received while the information is being presented to the adjudicator, and may be operable to produce an authorization signal representing whether or not the transaction is to proceed. The transaction controller may further include a transaction interface for receiving a transaction signal. The transaction controller may be operable to selectively permit the transaction signal to be communicated to a transaction processor, in response to the authorization signal.

The apparatus may further include a transaction interface for receiving a transaction message. The transaction controller may be operable to control whether or not the transaction message is transmitted to a transaction processor. The transaction controller may also be operable to associate the identification of the adjudicator with the transaction message.

The apparatus may also include a storage device for storing a transaction record associating the identification of the adjudicator with the transaction message.

In accordance with another aspect of the invention there is provided a transaction system comprising the apparatus as described above and further comprising a point of transaction terminal responsive to the authorization signal to selectively permit a transaction to proceed.

In accordance with another aspect of the invention there is provided a computer readable medium operable to provide instructions to a processor circuit to direct the processor circuit to authorize a transaction to proceed in response to receiving an identification of an adjudicator confirming that computer readable information retrieved from a card matches a feature of a bearer of the card while the information is being presented to the adjudicator.

In accordance with another aspect of the invention there is provided a signal comprising a segment representing a plurality of computer readable instructions for directing a processor circuit to authorize a transaction to proceed in response to receiving an identification of an adjudicator confirming that computer readable information retrieved from a card matches a feature of a bearer of the card while the information is being presented to the adjudicator.

In accordance with another aspect of the invention there is provided an apparatus for controlling a cardholder transaction The apparatus includes a device for receiving an indication that information stored on the card is being presented to the adjudicator, a device for receiving an identification of an adjudicator confirming that the information stored on the card matches a feature of a bearer of the card, and a device for producing a signal indicative of whether or not a transaction should proceed, in response to whether or not the identification of the adjudicator is received while the information is being presented to the adjudicator.

The device for producing may be operable to prevent the transaction from proceeding unless the identification is received while the information is being presented to the adjudicator, and may be operable to produce an authorization signal representing whether or not the transaction is to proceed.

The device for producing may be operable to receive a transaction signal and to selectively permit the transaction signal to be communicated to a transaction processor, in response to the authorization signal.

The apparatus may further include a device for reading the card to retrieve a feature file from the card, and a device for annunciating information contained in the feature file.

The apparatus also include a device for receiving a transaction message. This device may be operable to control whether or not the transaction message is transmitted to a transaction processor, and may be operable to associate an identity of the adjudicator with the transaction message. The apparatus may further include a device for storing the transaction record.

The apparatus may further include a sensing device for sensing an identity of the adjudicator. The sensing device may be operable to produce a code identifying the adjudicator.

In accordance with another aspect of the invention there is provided a card transaction apparatus including an input device, a card reader, an annunciation device, an identification interface, and a transaction controller. The input device is operable to receive input from a bearer of the card, and the card reader is operable to read a feature file from the card. The feature file includes a representation of a feature of an authorized user of the card. The annunciation device is operable to annunciate the representation of the feature in the feature file, to an adjudicator capable of confirming that the annunciated representation of the feature matches a feature of the bearer of the card. The identification interface is operable to receive an identification code from the adjudicator while the representation of the feature is being annunciated. The transaction controller is operable to cause the input from the bearer of the card, received at the input device, to be transmitted to a receiver in response to receipt of an identification code at the identification interface, while the representation of the feature is being annunciated.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention,

FIG. 1 is a block diagram of an apparatus according to a first embodiment of the invention;

FIG. 2 is a block diagram of an apparatus according to a second embodiment of the invention;

FIG. 3 is a perspective view of an apparatus according to a third embodiment of the invention.

### DETAILED DESCRIPTION

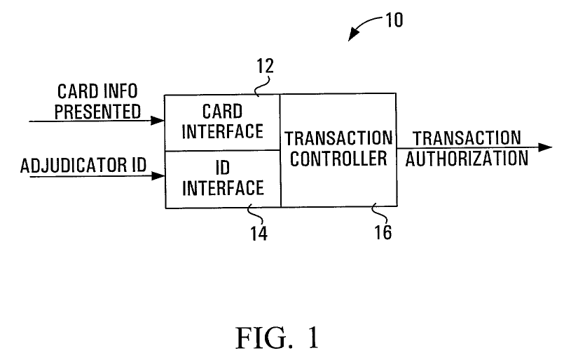

Referring to FIG. 1, an apparatus for controlling a cardholder transaction, according to a first embodiment of the invention is shown generally at 10. The apparatus 10 includes a card interface 12 for receiving an indication that information stored on a card is being presented to an adjudicator, an identification interface 14 for receiving an identification of the adjudicator confirming that the information stored on the card matches a feature of a bearer of the card, and a transaction controller 16 operable to produce a signal indicative of whether or not a transaction should proceed, in response to whether or not the identification of the adjudicator is received while the information is being presented to the adjudicator. In its simplest form, the apparatus of FIG. 1 may be implemented by a simple two input “AND” logic circuit, where the inputs of the circuit act as the card interface 12 and identification interface 14 respectively, and the “AND” circuit itself is operable to perform the above indicated function of the transaction controller 16. The “AND” circuit may have an output at which it produces an authorization signal, indicative of whether or not the transaction should proceed, in response to whether or not the identification of the adjudicator is received while the information is being presented to the adjudicator. This authorization signal may be used by a point of transaction terminal to permit or deny a transaction from proceeding.

The apparatus facilitates control of cardholder transactions as it authorizes a transaction to proceed in response to receiving an identification of an adjudicator confirming that information about a feature of the authorized card user matches a feature of the bearer of the card, while the information about the feature is being presented to the adjudicator. This forces the adjudicator to carefully compare the feature about the authorized card user with a feature of the card bearer, placing a higher degree of responsibility on the adjudicator to ensure that the card bearer is authorized to make transactions with the card. Transactions may include access control, credit card transactions, debit card transactions, or loyalty card transactions, for example.

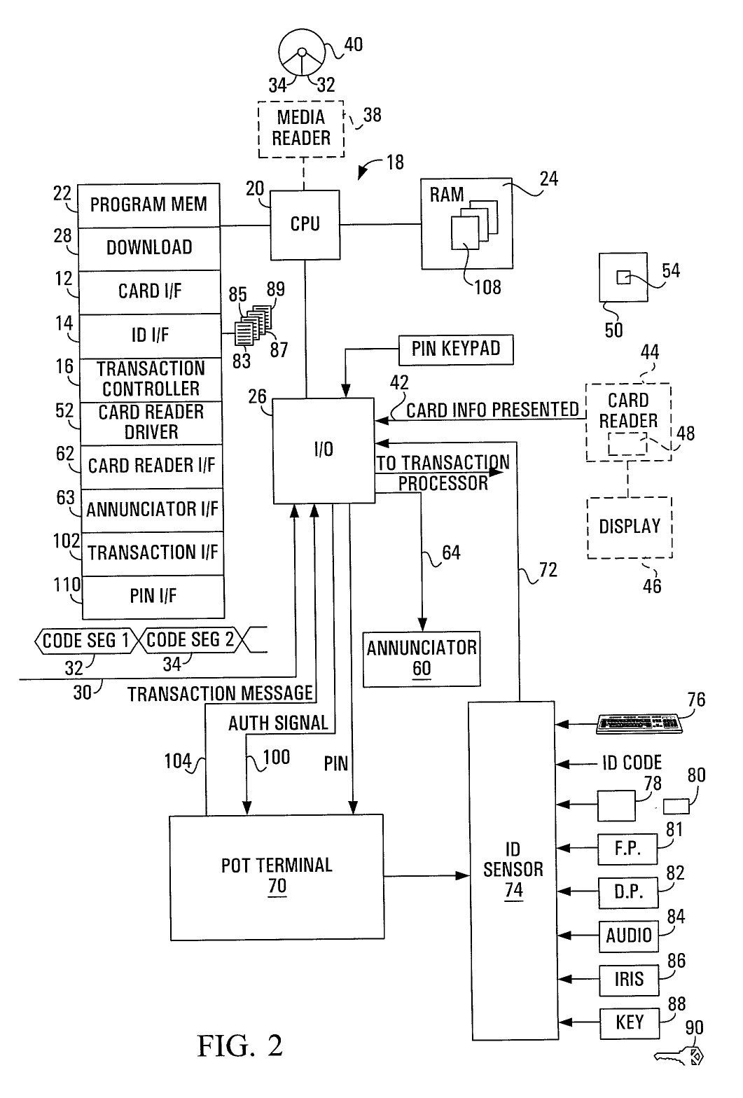

Referring to FIG. 2, an alternative embodiment employing a processor circuit implementation is shown. In this embodiment, the apparatus 10 is implemented in a processor circuit 18 comprised of a central processing unit 20, program memory 22, random access memory 24 and an input/output (I/O) port 26. Each of these components may be separate or embodied in a single integrated circuit, for example.

The program memory 22 may include computer readable instructions 28 which direct the processor circuit 18 to receive a download signal 30 at the I/O port 26, for example. The download signal 30 may include various code segments 32, 34 or blocks of computer readable instructions for storage in the program memory 22, the code segments implementing the card interface 12 and the identification interface 14 and for programming the processor circuit 18 to implement the transaction controller 16.

Alternatively, the processor circuit 18 may include a media reader 38 for reading a computer readable medium 40 on which the code segments 32, 34 of computer readable instructions may be stored, to download the code segments into the program memory 22 to implement the card interface 12, the identification interface 14 and the transaction controller 16.

The card interface 12 may direct the processor circuit 18 to interact with the I/O port 26 to cause the I/O port to receive a signal 42 indicating whether or not information received from a card is being presented. A card reader 44, may, for example, be connected to the I/O port 26 to facilitate communications between it and the processor circuit 18. The interaction between the card reader 44 and the processor circuit 18 may be as simple as the card reader providing a simple true/false signal to the processor circuit to indicate whether or not the card reader is presenting information stored on the card for use by an adjudicator. In such an embodiment, the card reader 44 may have a built in display 46, for example, and may include its own processor circuit 48 for reading information from a card 50 and presenting the information on the built in display and for producing and providing to the I/O port 26 the signal 42 indicating whether or not information received from a card is being presented. Or the card reader 44 may drive a remote display (not shown), for example.

Alternatively the apparatus may include, among the computer readable instructions stored in the program memory 22, a set of instructions known as a card reader driver 52 for example, to permit the processor circuit 18 to control the card reader 44.

Generally, the card reader 44 in this embodiment is able to read information from a “smart card” 50 of a type that has a sufficiently large amount of computer readable medium 54 to store a feature of the authorized card user. For example, the medium 54 may store an image file representing a facial image of the authorized card user, an audio file representative of the voice of the authorized card user, a fingerprint file representative of a fingerprint of the authorized card user, or a retinal scan or iris file representing a retinal scan or iris of the authorized card user. Generally, any data relating to any verifiable feature of the authorized card user may be stored in the medium 54 on the card 50. The data stored on the medium 54 may be encrypted and/or compressed, for example, for secure storage of large files. Various known or derived compression methods may be used to compress feature data, as required to achieve a desired resolution and quality of a feature representation. For example, an image compression method employing pre and post background processing with appropriate thresholding and morphology and color settings may permit wavelet decomposition/encoding techniques to be used to permit compression of an image measuring 480×640 pixels to a 750 bytes representation to provide an image of suitable resolution and quality.

Cards operable to store information of the type described are provided in a design complying with the ISO 7816 standard, for example. Smart cards designed to this standard may include a plurality of contacts which may engage with corresponding contacts on the card reader 44, to permit the card reader to access different computer readable storage areas on the card 50. Alternatively the card 50 may include an optical storage medium and the card reader may include an optical medium reader, such as a CD_ROM drive, for example. To simplify the description herein it will be assumed that the card 50 is operable to store a feature file representing a feature image of the authorized user and it will be assumed that the card reader 44 is operable to retrieve the feature file.

In general, a transaction system employing the apparatus 10 according to this embodiment of the invention includes a point of transaction terminal 70 and an annunciator 60 operable to annunciate a feature of the authorized card user as determined from the feature file stored on the card 50 and read by the card reader 44. Generally the annunciator 60 is operable to provide to the adjudicator sensory stimuli such as light or sound or any other sensory stimuli represented by the feature file stored on the card 50, to enable the adjudicator to make an informed decision as to whether or not the card bearer is the authorized card user.

The annunciator 60 may be controlled by the card reader 44, for example, as described above, or it may be controlled by the processor circuit 18, for example. In other words, the card reader 44 or the processor circuit 18 may act as an annunciation controller. In the case where the annunciator is controlled by the processor circuit 18, the program memory 22 includes a set of computer readable instructions which implement a card reader interface 62 for directing the processor circuit 18 to communicate with the card reader 44 to retrieve the feature file from the card 50 and further includes a set of instructions 63 which act as an annunciator interface operable to receive the feature file from the card to produce an annunciation signal 64 in response to the information stored on the card. The annunciation signal 64 may be an RGB signal or composite video signal, for example for driving a stand-alone annunciator such as a display device to control the annunciator 60 to cause an image derived from the feature file stored on the card 50 to be presented on the display device. The display device may include a LCD display, for example.

Generally, the card reader 44 and annunciator 60 would be positioned near the point of transaction terminal 70 to permit an adjudicator such as a waiter or store clerk, for example, to take the card 50 from the bearer, insert it in the card reader 44 and cause the representation provided by the feature file stored on the card to be presented by the annunciator 60 in such a manner that the adjudicator can compare the representation provided by the feature file with a feature of the bearer of the card. For example, if the feature file provides a representation of the face of the authorized user of the card 50, the adjudicator can simultaneously observe the face of the bearer of the card to determine whether the bearer is the authorized user. If so, the adjudicator may identify him/herself to the apparatus 10 to permit a transaction associated with the card 50 to proceed.

The adjudicator confirming that the information stored on the card 50 matches a feature of the bearer of the card may identify him/herself to the apparatus 10 by any of a number methods. The identification interface 14 directs the processor circuit 18 to receive the identification of the adjudicator and thus, the actual device which does the identifying need not be part of the apparatus 10 and need only provide for identification of the adjudicator to the apparatus. Such identification may be in the form of an identification signal 72 received at the I/O port 26, for example.

The identification signal 72 may be produced by any of a variety of devices which may include a sensing device or sensor 74 in communication with the identification interface 14 for sensing an identity of the adjudicator. For example, the sensor 74 may include a keyboard 76 enabling the adjudicator to enter his/her name and the identification interface 14 may interpret signals received at the I/O port 26, from the keyboard identifying the adjudicator. Alternatively, the sensor 74 may include the point of transaction terminal 70 for example, which may provide identification signals 72 to the I/O port 26. Alternatively, the sensor 74 may be operable to receive an identification code associated with the adjudicator. The sensor 74 may include a computer medium reader 78, for example, such as a credit card reader, for reading an identification code stored on a magnetic strip, or optical medium on a card 80 issued to the adjudicator.

Alternatively, the sensor 74 may include a fingerprint reader 81 operable to read and produce a representation of a fingerprint of the adjudicator and the identification interface 14 may include or have access to a library of reference fingerprint representations 83 of authorized adjudicators and may direct the processor circuit 18 to compare the fingerprint representation produced by the sensor 74 with the reference fingerprint representations to determine which adjudicator has confirmed the card bearer is an authorized user.

Or the sensor 74 may include a digitizing pad 82, operable to produce a representation of a signature of the adjudicator. The identification interface 14 may then include or have access to a library of reference signature representations 85 of authorized adjudicators and may direct the processor circuit to compare the signature representation produced by the digitizing pad with the reference signature representations 85 to determine which adjudicator has confirmed the card bearer is an authorized user.

Or, the sensor 74 may include an audio transducer 84 operable to produce a representation of an audio signature of the adjudicator and the identification interface 14 may include or have access to a library of reference audio signature representations 87 of authorized adjudicators and may direct the processor circuit 18 to compare the audio signature representation produced by the audio transducer 84 with the reference audio signature representations 87 to determine which adjudicator has confirmed the card bearer is an authorized user.

Or, the sensor 74 may include an iris sensor 86 operable to produce a representation of an iris signature of the adjudicator and the identification interface 14 may include or have access to a library of reference iris representations 89 of authorized adjudicators and may direct the processor circuit 18 to compare the iris signature representation produced by the iris sensor 86 with the reference iris signature representations 89 to determine which adjudicator has confirmed the card bearer is an authorized user.

Or the sensor 74 may include a key sensor 88 operable to receive a key code from a key 90, for example.

Generally, no matter what form of sensor is used, a code uniquely representing the confirming adjudicator is received at, produced by or caused to be produced by the identification interface 14.

The transaction controller 16 causes the processor circuit 18 to produce a signal indicative of whether or not a transaction should proceed, in response to whether or not the identification of the adjudicator is received while the information is being presented to the adjudicator. Generally, the transaction controller 16 is operable to prevent a transaction from proceeding unless the identification is received while the information is being presented to the adjudicator. To do this the transaction controller 16 directs the processor circuit 18 to cause the I/O port 26 to produce an authorization signal 100 representing whether or not the transaction is to proceed. This authorization signal 100 may be communicated to the point of transaction terminal 70, for example, to indicate whether or not a transaction at the point of transaction terminal is to proceed. The authorization signal 100 may be a simple logic level signal having two states; one representing the transaction is to proceed and the other representing the transaction is not to proceed. The point of transaction terminal 70 may use the authorization signal 100 to determine whether or not it will establish communications with a transaction approving authority, for example. Alternatively, the authorization signal 100 may be used to control a modem (not shown) used by the point of transaction terminal to communicate with a transaction approving authority.

The apparatus 10 may further include a transaction interface 102 for receiving, through the I/O port 26 from a transaction device such as the point of transaction terminal 70, a transaction signal 104 such as a message of the type that may be sent to a transaction processor, or a transaction approving authority such as a clearing center for example. The clearing center may be a VISA® center, for example. The transaction controller 16 may communicate with the transaction interface 102 to direct the processor circuit 18 to selectively permit such transaction signal 104 to be communicated through the I/O port 26 to the transaction processor, in response to the authorization signal 100, for example. Thus, the authorization signal 100 may be used internally by the processor circuit 18 to control the communication of the transaction signal 104 to a transaction processor.

The transaction interface 102 may also direct the processor circuit 18 to associate an identity of the adjudicator with the transaction message. The code identifying the adjudicator may then be sent along with the transaction message to the transaction processor circuit. In addition or alternatively, the transaction interface 102 may cause the processor circuit 18 to produce and store a transaction record 108 specifying details of the transaction in a storage device such as the RAM 24. The storage device may be part of the apparatus such as the RAM 24, or may be remote, in which case the processor circuit 18 would be in communication with a remote storage device.

The apparatus may further include a PIN code interface 110 which directs the processor circuit 18 to receive a signal at the I/O port 26, the signal representing a code entered by the bearer of the card. The code may be a personal identification number (PIN) entered by a bearer of the card 50, for example. The PIN would normally be transmitted to the point of transaction terminal 70, however, the apparatus 10 may act as a gate selectively permitting the PIN to reach the point of transaction terminal 70. To do this, the PIN code interface 110 may act as a identification code interface responsive to the authorization signal 100 to prevent the PIN from being passed to the point of transaction terminal 70 unless an identification of an adjudicator is received while the authorized card user information is being presented. Failure to receive the PIN at the point of transaction terminal 70 will thus prevent the transaction from proceeding.

It will be appreciated that the processor circuit 18 may be incorporated into the point of transaction terminal 70, or a processor in the point of transaction terminal may be programmed with the sets of codes shown in the program memory 22, to impart the functionality of the embodiment described above to a new or existing point of transaction terminal. If the point of transaction terminal 70 has a communications interface, it may be possible to download these code segments into the point of transaction terminal to impart this functionality. In this manner, existing point of transaction terminals may be “upgraded”, by way of plug-in or downloadable software specific to the point of transaction terminal for example, to incorporate the functionality described above.

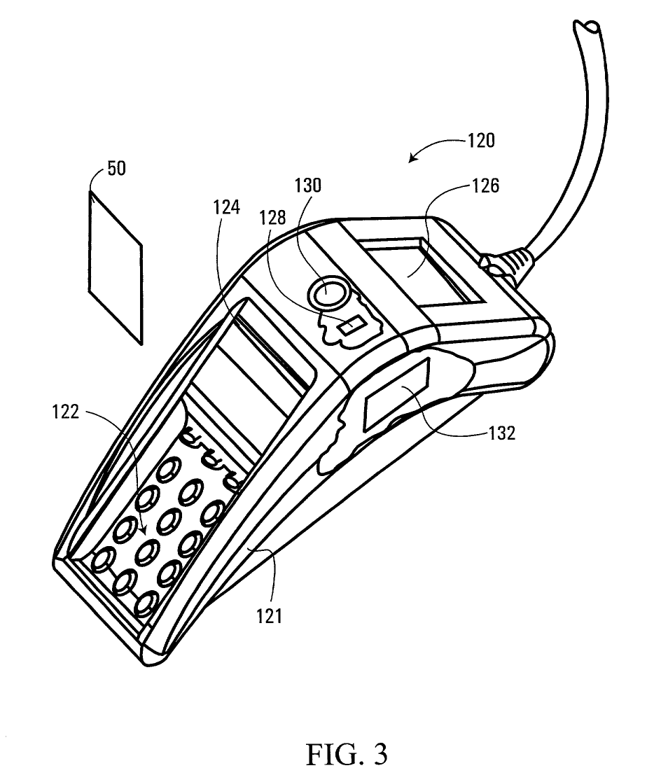

Alternatively, referring to FIG. 3, a separate peripheral unit 120 having a specially shaped housing 121 may be electrically connected to a point of transaction terminal in place of a conventional PIN pad. The separate peripheral unit 120 functions as a card transaction control apparatus and has an input device 122, which in this embodiment includes a PIN pad for receiving input such as a PIN code from a bearer of the card 50. The apparatus 120 also has a card reader 124 for reading a feature file from the card 50, the feature file including a representation of a feature of an authorized user of the card, such as the image file described above in connection with the second embodiment. The apparatus also has an annunciator 126, which, in this embodiment, includes an LCD panel for annunciating the representation of the feature in the feature file, to an adjudicator capable of confirming that the annunciated representation of said feature matches a feature of the bearer of the card. To facilitate this, the annunciator 126 is mounted on an opposite end of the apparatus 120 relative to the input device 122, such that the adjudicator can view the annunciator while the bearer of the card enters a PIN code.

The apparatus 120 further includes an identification interface 128 for receiving an identification code from the adjudicator. In this embodiment the apparatus 120 includes a sensor 130 operable to sense an object placed over the apparatus, such as a card programmed with a unique code associated with the adjudicator. The sensor 130 provides the identification code to the identification interface 128. The apparatus 120 further includes a transaction controller 132, which in this embodiment includes a processor circuit 132 operable to cause the input from the bearer of the card 50, typically the PIN, to be transmitted to a receiver such as a point of transaction terminal in response to receipt of an identification of an adjudicator at the identification interface 128 while the annunciated representation is being annunciated to the adjudicator. The processor circuit 18 described in the second embodiment may be incorporated into the housing 121 shown in FIG. 3, for example, along with the annunciator 126, the PIN pad 122 and the sensor 130, to provide a complete integral unit replacement to a conventional PIN pad input device, to provide the functionality described herein for greater security in making cardholder transactions.

While specific embodiments of the invention have been described and illustrated, such embodiments should be considered illustrative of the invention only and not as limiting the invention as construed in accordance with the accompanying claims.

What is claimed is:

1. A method of conducting a cardholder transaction, the method comprising:
presenting information stored on a card, in electronic form for review by an adjudicator;
sensing identification of the adjudicator reviewing the information at the time the information is presented; and
authorizing the completion of a transaction in response to receipt of said identification of said adjudicator.

2. A method of conducting a cardholder transaction, the method comprising:
authorizing a transaction to proceed in response to receiving an identification of an adjudicator confirming that computer readable information retrieved from a card matches a feature of a bearer of the card while said information is being presented to said adjudicator.

3. The method of claim 2 further comprising receiving data stored on said card to enable a representation of said data to be presented to said adjudicator to permit said adjudicator to compare said representation with said feature of said bearer of the card.

4. The method of claim 2 further comprising receiving said identification of said adjudicator.

5. The method of claim 4 wherein receiving said identification comprises receiving said identification while said information is being presented to said adjudicator.

6. The method of claim 2 wherein authorizing comprises enabling a message relating to said transaction to be transmitted to an account service.

7. The method of claim 2 further comprising preventing the transaction from proceeding unless an identity of said adjudicator is received.

8. The method of claim 2 wherein authorizing comprises associating the transaction with said adjudicator.

9. The method of claim 8 wherein associating comprises associating said identification of said adjudicator with said transaction.

10. The method of claim 2 further comprising causing said information to be presented to said adjudicator.

11. The method of claim 10 wherein causing comprises producing a signal for use by an annunciation device to cause said annunciation device to present said information to said adjudicator.

12. The method of claim 11 wherein causing comprises producing said annunciation signal in response to information received from said card.

13. The method of claim 2 further comprising receiving a personal identification number from said bearer of the card and preventing said personal identification number from being passed to a point of transaction terminal unless said identification of said adjudicator is received.

14. The method of claim 2 further comprising preventing transaction data from being transmitted to a transaction processor unless an adjudicator is identified while said information is being presented.

15. The method of claim 2 further comprising acquiring transaction data representing the transaction and associating said identification of said adjudicator with said transaction data.

16. The method of claim 15 further comprising producing a transaction record associating said identification of said adjudicator with said transaction data.

17. The method of claim 16 further comprising causing said transaction record to be stored.

18. The method of claim 2 further comprising reading data stored on said card to enable a representation of said data to be presented to said adjudicator to permit said adjudicator to compare said representation with said feature of said bearer of the card.

19. The method of claim 18 wherein reading comprises retrieving an image file representing an image from said card.

20. The method of claim 19 further comprising causing said image to be presented to said adjudicator.

21. The method of claim 20 further comprising producing a representation of said image for viewing by said adjudicator.

22. The method of claim 21 further comprising sensing an identity of said adjudicator while said image is being presented to produce said identification of said adjudicator.

23. The method of claim 18 wherein reading comprises retrieving an audio file from said card.

24. The method of claim 18 wherein reading comprises retrieving a fingerprint file from said card.

25. The method of claim 2 wherein receiving said confirmation comprises sensing an identity of said adjudicator.

26. The method of claim 25 wherein sensing comprises receiving an identification code associated with said adjudicator.

27. The method of claim 25 wherein sensing comprises reading, from a computer readable medium, an identification code identifying said adjudicator.

28. The method of claim 25 wherein sensing comprises producing a representation of a fingerprint of said adjudicator and comparing said representation to a reference fingerprint to determine the identity of said adjudicator.

29. The method of claim 25 wherein sensing comprises producing a representation of a signature of said adjudicator and comparing said signature to a reference signature representation to determine the identity of said adjudicator.

30. The method of claim 25 wherein sensing comprises producing a representation of an audio signature of said adjudicator and comparing said signature to a reference audio signature representation to determine the identity of said adjudicator.

31. The method of claim 25 wherein sensing comprises producing a representation of an iris signature of said adjudicator and comparing said representation with a reference iris signature representation to determine the identity of said adjudicator.

32. The method of claim 25 wherein sensing comprises receiving a key code from a key sensor operable to sense a key associated with said adjudicator.

33. An apparatus for controlling a cardholder transaction, the apparatus comprising:
a card interface for receiving an indication that information stored on a card is being presented to an adjudicator;
an identification interface for receiving an identification of said adjudicator confirming that said information stored on said card matches a feature of a bearer of the card; and
a transaction controller operable to produce a signal indicative of whether or not a transaction should proceed, in response to whether or not said identification of said adjudicator is received while said information is being presented to said adjudicator.

34. The apparatus of claim 33 wherein said transaction controller is operable to prevent the transaction from proceeding unless said identification is received while said information is being presented to said adjudicator.

35. The apparatus of claim 34 wherein said transaction controller produces an authorization signal representing whether or not the transaction is to proceed.

36. The apparatus of claim 33 wherein said transaction controller further comprises a transaction interface for receiving a transaction signal and wherein said transaction controller is operable to selectively permit said transaction signal to be communicated to a transaction processor, in response to said authorization signal.

37. The apparatus of claim 33 further comprising an annunciation controller for controlling annunciation of information retrieved from said card.

38. The apparatus of claim 33 further comprising an annunciator interface for receiving information stored on said card and for producing an annunciation signal in response to said information stored on said card.

39. The apparatus of claim 38 wherein said annunciation signal is operable to control an annunicator to annunciate said information.

40. The apparatus of claim 39 wherein said annunication signal is operable to cause an image derived from said information to be produced on a display.

41. The apparatus of claim 33 further comprising a transaction interface for receiving a transaction message and wherein said transaction controller is operable to control whether or not said transaction message is transmitted to a transaction processor.

42. The apparatus of claim 41 wherein said transaction controller is operable to associate said identification of said adjudicator with said transaction message.

43. The apparatus of claim 42 further comprising a storage device for storing a transaction record associating said identification of said adjudicator with said transaction message.

44. The apparatus of claim 33 further comprising an identification code interface operable to receive a code from said bearer of the card and wherein said transaction controller is operable to prevent said code from being passed to a point of transaction terminal unless said identification of said adjudicator is received.

45. The apparatus of claim 33 further comprising a card reader in communication with said card interface, for reading data stored on said card to enable a representation of said data to be presented to said adjudicator to permit said adjudicator to compare said representation with said feature of said bearer of the card.

46. The apparatus of claim 45 further comprising a card reader driver operable to control said card reader to retrieve an image file from said card.

47. The apparatus of claim 46 further comprising an annunication interface operable to receive said image file from said card reader interface and to provide said image file to an annunciator to cause said image to be presented to said adjudicator.

48. The apparatus of claim 47 further comprising an annunciator in communication with said annunciator interface for producing a representation of said image file for viewing by said adjudicator.

49. The apparatus of claim 47 wherein said transaction controller is operable to receive said identification of said adjudicator while said image is being presented.

50. The apparatus of claim 45 wherein said card reader driver is operable to control said card reader to retrieve an audio file from said card.

51. The apparatus of claim 45 wherein said card reader driver is operable to control said card reader to retrieve a fingerprint file from said card.

52. The apparatus of claim 33 further comprising a sensor in communication with said identification interface for sensing an identity of said adjudicator.

53. The apparatus of claim 52 wherein said sensor is operable to receive an identification code associated with said adjudicator.

54. The apparatus of claim 52 wherein said sensor is operable to read said identification code from a computer readable medium.

55. The apparatus of claim 52 wherein said sensor is operable to produce a representation of a fingerprint of said adjudicator and wherein said identification interface is operable to compare said fingerprint representation with a reference fingerprint representation to determine the identity of said adjudicator.

56. The apparatus of claim 52 wherein said sensor is operable to produce a representation of a signature of said adjudicator and wherein said identification interface is operable to compare said signature representation with a reference signature representation to determine the identity of said adjudicator.

57. The apparatus of claim 52 wherein said sensor is operable to producing a representation of an audio signature of said adjudicator and wherein said identification interface is operable to compare said audio signature representation with a reference audio signature representation to determine the identity of said adjudicator.

58. The apparatus of claim 52 wherein said sensor is operable to produce a representation of an iris signature of said adjudicator and wherein said identification interface is, operable to compare said iris signature representation with a reference iris signature representation to determine the identity of said adjudicator.

59. The apparatus of claim 52 wherein said sensor is operable to produce a key code in response to sensing a key associated with said adjudicator.

60. A transaction system comprising the apparatus of claim 33 and further comprising a point of transaction terminal responsive to said authorization signal to selectively permit a transaction to proceed.

61. A computer readable medium operable to provide instructions to a processor circuit to direct the processor circuit to authorize a transaction to proceed in response to receiving an identification of an adjudicator confirming that computer readable information retrieved from a card matches a feature of a bearer of the card while said information is being presented to said adjudicator.

62. A signal comprising a segment representing a plurality of computer readable instructions for directing a processor circuit to authorize a transaction to proceed in response to receiving an identification of an adjudicator confirming that computer readable information retrieved from a card matches a feature of a bearer of the card while said information is being presented to said adjudicator.

63. An apparatus for controlling a cardholder transaction, the apparatus comprising:
means for receiving an indication that information stored on said card is being presented to said adjudicator;
means for receiving an identification of an adjudicator confirming that said information stored on said card matches a feature of a bearer of the card; and
means for producing a signal indicative of whether or not a transaction should proceed, in response to whether or not said identification of said adjudicator is received while said information is being presented to said adjudicator.

64. The apparatus of claim 63 wherein said means for producing is operable to prevent the transaction from proceeding unless said identification is received while said information is being presented to said adjudicator.

65. The apparatus of claim 64 wherein said means for producing is operable to produce an authorization signal representing whether or not the transaction is to proceed.

66. The apparatus of claim 63 wherein said means for producing is operable to receive a transaction signal and to selectively permit said transaction signal to be communicated to a transaction processor, in response to said authorization signal.

67. The apparatus of claim 63 further comprising means for reading said card to retrieve a feature file from said card.

68. The apparatus of claim 67 further comprising means for annunciating information contained in said feature file.

69. The apparatus of claim 63 further comprising means for receiving a transaction message, said means being operable to control whether or not said transaction message is transmitted to a transaction processor.

70. The apparatus of claim 69 wherein said means for receiving is operable to associate an identity of said adjudicator with said transaction message.

71. The apparatus of claim 70 further comprising means for storing said transaction record.

72. The apparatus of claim 63 further comprising sensing means for sensing an identity of said adjudicator.

73. The apparatus of claim 72 wherein said sensing means is operable to produce a code identifying said adjudicator.

74. A card transaction apparatus comprising:
an input device for receiving input from a bearer of the card;
a card reader for reading a feature file from said card, said feature file including a representation of a feature of an authorized user of the card;
an annunciator for annunciating said representation of said feature in said feature file, to an adjudicator capable of confirming that the annunciated representation of said feature matches a feature of the bearer of the card;
an identification interface for receiving an identification code from said adjudicator while said representation of said feature is being annunciated; and
a transaction controller operable to cause said input from said bearer of the card received at said input device to be transmitted to a receiver, in response to receipt of an identification code at said identification interface while said representation of said feature is being annunciated.
